(19) United States
(12) Patent Application Publication
(10) Pub. No.: US 2023/0213712 A1
(43) Pub. Date: Jul. 6, 2023

(54) OPTICAL RECEPTACLE AND OPTICAL MODULE

(71) Applicant: Enplas Corporation, Saitama (JP)

(72) Inventors: Honoka SATO, Saitama (JP); Ayano KON, Saitama (JP)

(21) Appl. No.: 18/062,805

(22) Filed: Dec. 7, 2022

(30) Foreign Application Priority Data
Dec. 8, 2021 (JP) 2021-199414

(51) Int. Cl. G02B 6/42

(52) U.S. Cl. CPC G02B 6/4214

(57) ABSTRACT

An optical receptacle of the present invention includes: a first optical surface configured to allow light emitted from the photoelectric conversion element to enter the optical receptacle; a second optical surface configured to emit, toward the optical transmission member, the light having entered through the first optical surface; a positioning part configured to position an end face of the optical transmission member in such a way that the end face faces the second optical surface; and a region disposed at an optical surface in the optical receptacle. The region is configured in such a way that as a distance from an emission position of the light on the second optical surface to a center of the second optical surface increases, a distance from a position where the light intersects a central axis of the second optical surface to the second optical surface increases.

This application is entitled to the benefit of Japanese Patent Application No. 2021-199414, filed on Dec. 8, 2021, the disclosure of which including the specification, drawings and abstract is incorporated herein by reference in its entirety.

### TECHNICAL FIELD

The present invention relates to an optical receptacle and an optical module.

### BACKGROUND ART

Conventionally used for optical communications that uses an optical transmission member, such as an optical fiber or an optical waveguide, is an optical module including a light emitting element such as a surface-emitting laser (for example, a vertical cavity surface emitting laser (VCSEL)) or light receiving element such as a photodetector. The optical module includes one or more photoelectric conversion elements (light emitting elements or light receiving elements), and an optical receptacle for transmission, reception, or transmission and reception.

Patent Literature (hereinafter, referred to as PTL) 1 describes a lens made of resin for optical communication. The lens is used for condensing light fluxes, having wavelength λ and emitted from a semiconductor laser, toward the end face of a single-mode fiber. The lens of PTL 1 includes a diffraction structure formed on the optical surface on its output side for reducing fluctuations at the focal position when the temperature changes. The diffraction structure is composed of a plurality of steps formed on concentric circles.

In the lens of PTL 1, for example, when the ambient temperature rises, the diffraction angle of diffracted light generated from the diffraction structure changes according to the increase in the oscillation wavelength of the semiconductor laser. This configuration corrects the shift in a focal position caused by the change in the refractive index of the lens due to the ambient temperature change.

### CITATION LIST

### Patent Literature

PTL 1
WO2012/128142

### SUMMARY OF INVENTION

### Technical Problem

PTL 1 has not fully studied for problems such as the coupling efficiency reduction caused by the change in the position of the end face of optical fiber due to the change in the ambient temperature.

An object of the present invention is to provide an optical receptacle capable of reducing the change in coupling efficiency when the ambient temperature changes. Another object of the present invention is to provide an optical module including the optical receptacle.

### Solution to Problem

An optical receptacle according to an embodiment of the present invention is configured to optically couple a photoelectric conversion element and a optical transmission member when the optical receptacle is disposed between the photoelectric conversion element and the optical transmission member. The optical receptacle includes the following: a first optical surface configured to allow light emitted from the photoelectric conversion element to enter the optical receptacle; a second optical surface configured to emit, toward the optical transmission member, the light having entered through the first optical surface; a positioning part configured to position an end face of the optical transmission member in such a way that the end face faces the second optical surface; and a region disposed at at least one of the first optical surface, the second optical surface, and another optical surface on an optical path in the optical receptacle. The region is configured in such a way that as a distance from an emission position of the light on the second optical surface to a center of the second optical surface increases, a distance from a position where the light intersects a central axis of the second optical surface to the second optical surface increases.

An optical module according to an embodiment of the present invention includes the following: an optical transmission member and the optical receptacle of the present invention.

### Advantageous Effects of Invention

The present invention can provide an optical receptacle capable of reducing the change in coupling efficiency when the ambient temperature changes. Therefore, the present invention can provide an optical receptacle and an optical module both enabling satisfactory optical communication independent of the ambient temperature.

### BRIEF DESCRIPTION OF DRAWINGS

FIG. 1 is a cross-sectional view of an optical module according to Embodiment 1 of the present invention;

FIGS. 2A to 2D illustrate the structure of an optical receptacle according to Embodiment 1 of the present invention;

FIG. 3 is a schematic diagram for explaining the relationship between light emitted from a second optical surface and a second central axis of the second optical surface;

FIGS. 4A to 4C illustrate the size of spots on an end face of an optical transmission member in the optical module according to Embodiment 1 of the present invention;

FIGS. 5A to 5C illustrate the size of spots on an end face of an optical transmission member in an optical module according to a comparative example;

FIG. 6 is a cross-sectional view of an optical module according to Embodiment 2 of the present invention;

FIGS. 7A to 7C illustrate the structure of an optical receptacle according to Embodiment 2 of the present invention; and

FIGS. 8A and 8B also illustrate the structure of the optical receptacle according to Embodiment 2 of the present invention.

### DESCRIPTION OF EMBODIMENTS

Hereinafter, optical receptacles and optical modules according to embodiments of the present invention will be described in detail with reference to the accompanying drawings.

### Embodiment 1

Configuration of Optical Module

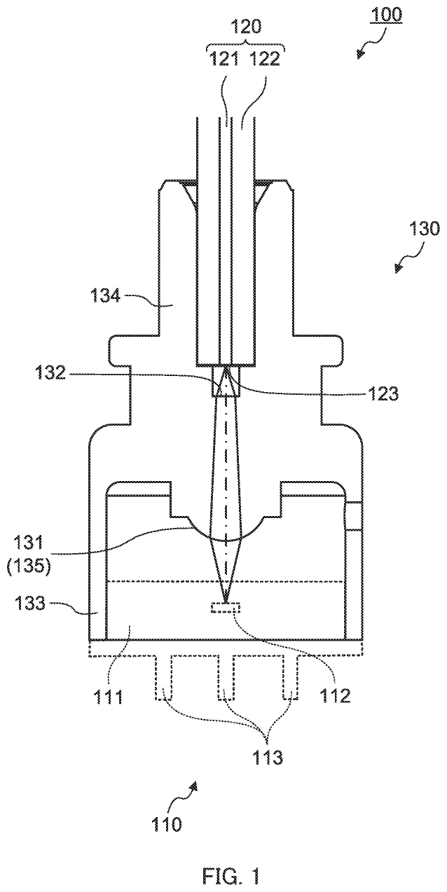

FIG. 1 is a cross-sectional view of optical module 100 according to Embodiment 1 of the present invention. In FIG. 1, photoelectric conversion element package 110 is indicated by a dotted line. In addition, hatching of optical module 100 is omitted for the illustration of optical paths in FIG. 1.

As illustrated in FIG. 1, optical module 100 includes optical transmission member 120 and optical receptacle 130. Optical module 100 is connected to photoelectric conversion element package 110 with optical transmission member 120 connected to optical receptacle 130. Optical module 100 is for transmission, and configured to guide light emitted from photoelectric conversion element package 110 to the end face of optical transmission member 120. The ambient temperature at which optical module 100 is used is, for example, preferably in the range of −40 to +85° C., more preferably in the range of 0 to +60° C.

Photoelectric conversion element package 110 includes housing 111, photoelectric conversion element 112, and at least one lead 113. Photoelectric conversion element 112 is disposed inside housing 111. Photoelectric conversion element package 110 is fixed to optical receptacle 130.

In the present embodiment, photoelectric conversion element 112 is a light emitting element and is disposed inside housing 111. The light emitting element is, for example, a vertical cavity surface emitting laser (VCSEL).

One end of lead 113 is connected to photoelectric conversion element 112. Lead 113 is disposed so as to protrude from the bottom surface of housing 111. The number of leads 113 is not limited. In the present embodiment, the number of leads 113 is three. In the present embodiment, three leads 113 are disposed at regular intervals in the circumferential direction when photoelectric conversion element package 110 is viewed from the bottom (not illustrated).

Optical receptacle 130 optically couples photoelectric conversion element package 110, which includes a light emitting element, with end face 123 of optical transmission member 120 when optical receptacle 130 is disposed between photoelectric conversion element package 110 and optical transmission member 120. In optical module 100 for transmission as in the present embodiment, optical receptacle 130 allows thereon incidence of light emitted from a light emitting element serving as photoelectric conversion element 112, and emits the incident light toward end face 123 of optical transmission member 120.

The type of optical transmission member 120 is not limited. Examples of optical transmission member 120 include optical fibers and optical waveguides. In the present embodiment, optical transmission member 120 is an optical fiber and includes core 121 and cladding 122. The optical fiber may be a single-mode optical fiber or a multi-mode optical fiber, but the single-mode optical fiber is preferred.

Configuration of Optical Receptacle

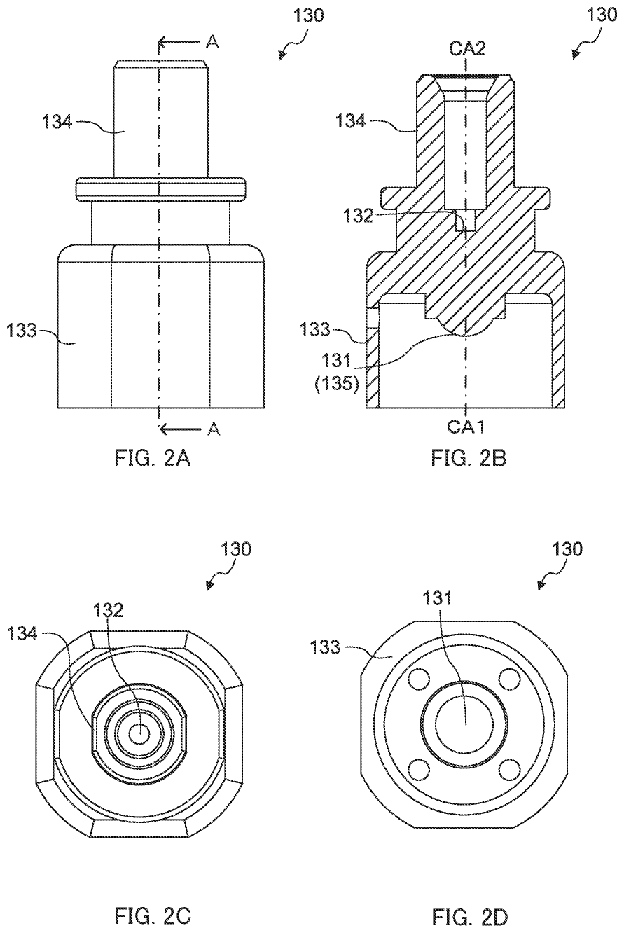

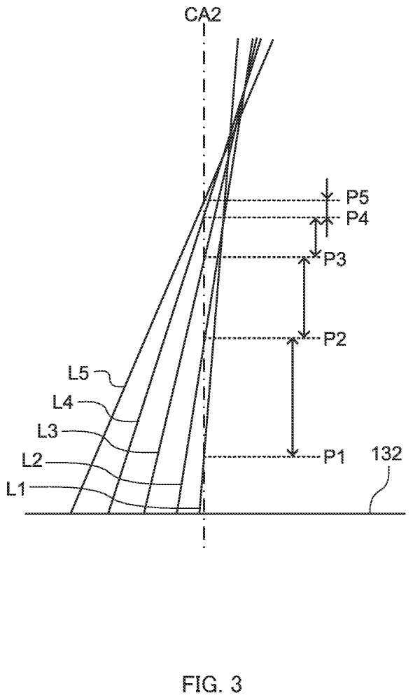

FIGS. 2A to 2D illustrate the structure of optical receptacle 130 according to Embodiment 1 of the present invention. Regarding optical receptacle 130, FIG. 2A is a front view, FIG. 2B is a cross-sectional view taken along line A-A of FIG. 2A, FIG. 2C is a plan view, and FIG. 2D is a bottom view. FIG. 3 is a schematic diagram for explaining the relationship between second central axis CA2 of second optical surface 132 and light L1 to light L5 emitted from second optical surface 132.

Optical receptacle 130 is a substantially cylindrical optical member. In the present embodiment, optical transmission member 120 is fixed to one end of optical receptacle 130, and photoelectric conversion element package 110 is fixed to the other end of the optical receptacle. As illustrated in FIGS. 2A to 2D, optical receptacle 130 includes first optical surface 131, second optical surface 132, positioning part 134, and first region (region) 135. In addition to the above components, optical receptacle 130 further includes fixing part 133 for fixing photoelectric conversion element package 110, in the present embodiment.

Optical receptacle 130 is formed of a material that allows light having a wavelength used for optical communication to pass therethrough. Examples of the material of optical receptacle 130 include transparent resins including polyetherimide (PEI), such as ULTEM (registered trademark), and cyclic olefin resins, and glass. The material of optical receptacle 130 is preferably a resin from the viewpoint of moldability. In addition, optical receptacle 130 is integrally molded to be produced by, for example, injection molding.

First optical surface 131 is configured to allow light emitted from photoelectric conversion element package 110 φhotoelectric conversion element) to enter optical receptacle 130. First optical surface 131 may have any shape. First optical surface 131 may be a surface of a convex lens convex toward photoelectric conversion element package 110, a surface of a concave lens concave relative to photoelectric conversion element package 110, or a flat surface. In the present embodiment, first optical surface 131 is a surface of a convex lens convex toward photoelectric conversion element package 110. First optical surface 131 may have any shape in plan view. The shape of first optical surface 131 in plan view may be circular or elliptical. In the present embodiment, the shape of first optical surface 131 in plan view is circular (circularly symmetrical).

First central axis CA1 of first optical surface 131 may or may not be perpendicular to the surface of photoelectric conversion element 112. In the present embodiment, first central axis CA1 is perpendicular to the surface of photoelectric conversion element 112. In addition, first central axis CA1 of first optical surface 131 preferably coincides with the center of the surface of photoelectric conversion element package 110 in plan view. Fixing part 133 is disposed around first optical surface 131.

Fixing part 133 is disposed to surround first central axis CA1 of first optical surface 131 and holds photoelectric conversion element package 110 at a position facing first optical surface 131. Fixing part 133 may have any shape as long as the fixing part can hold photoelectric conversion element package 110 with the inner surface thereof. In the present embodiment, the shape of fixing part 133 is cylindrical. Photoelectric conversion element package 110 is inserted into fixing portion 133. Photoelectric conversion element package 110 can be fixed to optical receptacle 130 by, for example, inserting photoelectric conversion element package 110 into fixing part 133 and fixing the package with a cured product of an adhesive.

Second optical surface 132 is configured to emit light—having entered through first optical surface 131 and traveling inside optical receptacle 130—toward end face 123 of optical transmission member 120. Second optical surface 132 may have any shape. Second optical surface 132 may be a surface of a convex lens convex toward optical transmission member 120, or a flat surface. In the present embodiment, second optical surface 132 is a flat surface. Second optical surface 132 may have any shape in plan view. The shape of second optical surface 132 in plan view may be circular or elliptical. In the present embodiment, second optical surface 132 is circularly symmetrical, and the shape of second optical surface 132 in plan view is circular.

Second central axis CA2 of second optical surface 132 may or may not be perpendicular to end face 123 of optical transmission member 120. In the present embodiment, second central axis CA2 is perpendicular to the end face of optical transmission member 120. Second central axis CA2 of second optical surface 132 preferably coincides with the center of the end face of optical transmission member 120 in plan view. In the present embodiment, first central axis CA1 and second central axis CA2 are located on the same straight line. Positioning part 134 is disposed around second optical surface 132 in plan view.

First region 135 controls light emitted from second optical surface 132 in such a way that as the distance from the emission position of light on second optical surface 132 to the center of second optical surface 132 increases, the distance from a position where the light intersects the central axis (second central axis CA2) of second optical surface 132 to second optical surface 132 increases. In other words, light emitted from second optical surface 132 is not condensed at one point in the present embodiment. First region 135 may be disposed at first optical surface 131 or at second optical surface 132. In the present embodiment, first region 135 is disposed in the central portion of first optical surface 131 so as to include the center of first optical surface 131. The shape of first region 135 in plan view is preferably circularly symmetrical. The proportion of first region 135 in the first optical surface 131 is preferably as large as possible. For example, the proportion of first region 135 in first optical surface 131 is 75% or more, 90% or more, or 95% or more. First optical surface 131 may be composed only of first region 135.

First optical surface 131 may perform the light control in such a way that light other than the light controlled as described above is also generated (not illustrated). For example, first optical surface 131 may include a second region outside first region 135. The second region is configured in such a way that as the distance from the emission position of light on second optical surface 132 to the center of second optical surface 132 increases, the distance from the position, where the light intersects the central axis of second optical surface 132 (second central axis CA2), to second optical surface 132 decreases. The second region is preferably located away from first central axis CA1 (located in the outer peripheral portion of first optical surface 131). This is because the light emitted from the second region located away from first central axis CA1 has a low light intensity.

Positioning part 134 is disposed so as to surround second central axis CA2 of second optical surface 132 at a position farther from first optical surface 131 than second optical surface 132 is. Positioning part 134 holds the end of optical transmission member 120 in such a way that end face 123 faces second optical surface 132. The shape of positioning part 134 is substantially cylindrical.

As described above, at least a portion of first optical surface 131 (first region 135) is configured in such a way that as the distance from the emission position of light on second optical surface 132 to the center of second optical surface 132 increases, the distance from the position, where the light intersects the central axis of second optical surface 132 (second central axis CA2), to second optical surface 132 increases. This configuration allows light emitted from second optical surface 132 is condensed within a predetermined range (between intersection points P1 and P5 in FIG. 3) on the central axis (second central axis CA2) of second optical surface 132 instead of at one point on the central axis (second central axis CA2) of second optical surface 132. Optical transmission member 120 is preferably disposed in such a way that end face 123 thereof is always located within this range during use. From this point of view, at the temperature of +25° C., positioning part 134 preferably fixes optical transmission member 120 in such a way that end face 123 is located at a position farther from second optical surface 132 than the following position is: the position (intersection point P1 in FIG. 3) where light emitted from the vicinity of the center of second optical surface 132 (excluding the center of second optical surface 132) intersects the central axis (second central axis CA2) of second optical surface 132. In addition, at the temperature of +25° C., positioning part 134 preferably fixes optical transmission member 120 in such a way that end face 123 is located at a position closer to second optical surface 132 than the following position is: the position (intersection point P5 in FIG. 3) where light emitted from the vicinity of the outer edge of first region 135 of second optical surface 132 intersects the central axis (second central axis CA2) of second optical surface 132. Furthermore, in the entire temperature range from −40 to +85° C., positioning part 134 preferably fixes optical transmission member 120 in such a way that end face 123 is located at a position where light emitted from first region 135 intersects the central axis (second central axis CA2) of second optical surface 132. In other words, in the entire temperature range from −40 to +85° C., positioning part 134 preferably fixes optical transmission member 120 in such a way that end face 123 is located between the following positions: a position (intersection point P1 in FIG. 3), where light emitted from the vicinity of the center of second optical surface 132 (excluding the center of second optical surface 132) intersects the central axis (second central axis CA2) of second optical surface 132; and a position (intersection point P5 in FIG. 3), where light emitted from the vicinity of the outer edge of first region 135 of second optical surface 132 intersects the central axis (second central axis CA2) of the second optical surface 132.

Relationship Between Light Emitted from Second Optical Surface and Second Central Axis

In the following, the relationship between light emitted from second optical surface 132 and second central axis CA2 of second optical surface 132 in optical module 100 according to the present embodiment will be described. FIG. 3 is a schematic diagram for explaining the relationship between the light emitted from second optical surface 132 and second central axis CA2 of second optical surface 132. FIG. 3 illustrates only light beams on the left side of second central axis CA2, and omits light beams on the right side of second central axis CA2.

FIG. 3 illustrates light L1 to light L5 emitted from second optical surface 132. Light L1 refers to light emitted from the vicinity of second central axis CA2 of second optical surface 132, light L5 refers to light emitted from the vicinity of the outer edge of second optical surface 132, and each of light L2 to light L4 refers to emitted light between light L1 and light L5. Intersection points P1 to P5 each refers to an intersection point between corresponding one of light L1 to light L5 and second central axis CA2. Intersection point P1 refers to the intersection point between light L1 and second central axis CA2, intersection point P2 refers to the intersection point between light L2 and second central axis CA2, intersection point P3 refers to the intersection point between light L3 and second central axis CA2, intersection point P4 refers to the intersection point between light L4 and second central axis CA2, and intersection point P5 refers to the intersection point between light L5 and second central axis CA2.

As illustrated in FIG. 3, light L1 emitted from the vicinity of second central axis CA2 of second optical surface 132 intersects second central axis CA2 near second optical surface 132. On the other hand, light L2 to light L5 emitted from second optical surface 132 intersect second central axis CA2 at positions (see intersection points P2 to P5) gradually separating away from second optical surface 132 as the emission point moves from the center of second optical surface 132 toward the outer edge of second optical surface 132. In the present embodiment, intersection point P1 is closest to second optical surface 132, and intersection points P2, P3, P4, and P5 are located farther from second optical surface 132 in this order. As described above, end face 123 of optical transmission member 120 is disposed between intersection points P1 and P5 in the present embodiment. In the present embodiment, optical transmission member 120 is fixed in such a way that end face 123 is located at the point approximately in the middle between intersection points P1 and P5 at 25° C.

First region 135 is configured in such a way that a distance (1) is longer than a distance (2). The distance (1) is defined as the distance between the following points A and B: point A where light emitted from a point at a distance n from the central axis (second central axis CA2) of second optical surface 132 intersects the central axis (second central axis CA2) of the second optical surface 132; and point B where light emitted from a point at a distance n+a from the central axis (second central axis CA2) of second optical surface 132 intersects the central axis (second central axis CA2) of the second optical surface 132. The distance (2) is defined as the distance between the following points C and D: point C where light emitted from a point at a distance m (where m>n) from the central axis (second central axis CA2) of second optical surface 132 intersects the central axis (second central axis CA2) of the second optical surface 132; and point D where light emitted from a point at a distance m+a from the central axis (second central axis CA2) of second optical surface 132 intersects the central axis (second central axis CA2) of the second optical surface 132. Units of n, m and a are, for example, mm or μm. As described above, at least portion of (region in) first optical surface 131 is formed in such a way that the distance between the following intersection points becomes shorter as the emission position moves away from the center of second optical surface 132: intersection points of respective two light beams, emitted from second optical surface 132 and adjacent to each other with a predetermined distance therebetween, with second central axis CA2. In the example of FIG. 3, the distance between intersection points P1 and P2 is longer than the distance between intersection points P2 and P3. Similarly, the distance between intersections P2 and P3 is longer than the distance between intersections P3 and P4, and the distance between intersections P3 and P4 is longer than the distance between intersections P4 and P5. Therefore, the condensing density of light emitted from the vicinity of the center of second optical surface 132 and having high intensity is reduced, and the condensing density of light emitted from the vicinity of the outer edge of second optical surface 132 and having low intensity is increased, thereby allowing the intensity of the light between intersection points P1 and P5 to be substantially uniform.

Change in Spot Size According to Temperature Change

The following examination is then conducted: the spot size of light emitted from second optical surface 132 on end face 123 of optical transmission member 120 when the ambient temperature at which optical module 100 is used is changed. For comparison, an optical module including an optical receptacle formed in such a way that light emitted from second optical surface is condensed at one point on second central axis CA2 is also examined.

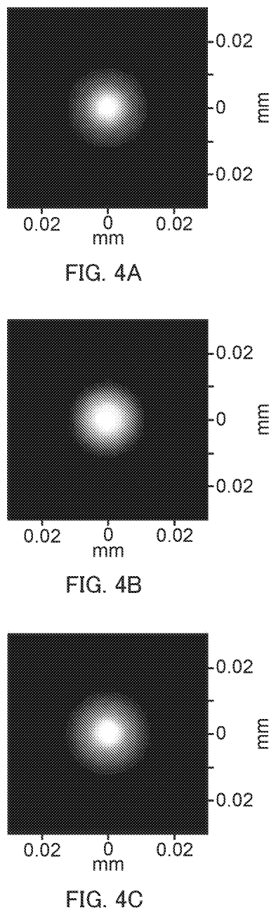

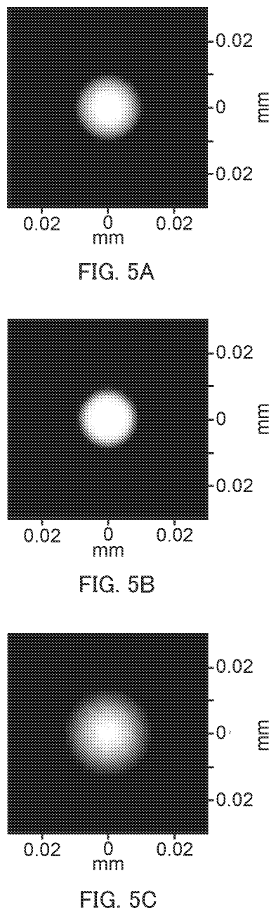

FIGS. 4A to 4C show spots of light emitted from second optical surface 132—each spot on end face 123 of optical transmission member 120—in optical module 100 according to the present embodiment. FIG. 4A shows a spot when the ambient temperature is 0° C., FIG. 4B shows a spot when the ambient temperature is 25° C., and FIG. 4C shows a spot when the ambient temperature is 70° C. FIGS. 5A to 5C show spots of light emitted from the second optical surface—each on the end face of the optical transmission member—in the optical module according to the comparative example. FIG. 5A shows a spot when the ambient temperature is 0° C., FIG. 5B shows a spot when the ambient temperature is 25° C., and FIG. 5C shows a spot when the ambient temperature is 70° C. The ordinate and abscissa in FIGS. 4A to 4C and 5A to 5C indicate the distance (mm) from the center of each spot.

As illustrated in FIGS. 4A to 4C, the spot size on end face 123 is substantially constant regardless of the ambient temperature (0° C., 25° C., 70° C.) in optical module 100 according to the present embodiment. The reason therefor can be considered as follows: at least a portion of first optical surface 131 is configured to condense light within a predetermined range instead of at one point on second central axis CA2; therefore, the amount of light reaching end face 123 of optical transmission member 120 can be kept substantially constant even when the optical receptacle expands or contracts, due to the change in the ambient temperature, to shift the position of the focal point of second optical surface 132 or the position of end face 123 of optical transmission member 120. When the ambient temperature is 0° C., the spot size of light with an intensity ratio of 50% or more is φ10 μm, and the spot size of light with an intensity ratio of 13.5% or more is φ21 μm. When the ambient temperature is 25° C., the spot size of light with an intensity ratio of 50% or more is φ13 μm, and the spot size of light with an intensity ratio of 13.5% or more is φ21 μm. When the ambient temperature is 70° C., the spot size of light with an intensity ratio of 50% or more is φ12 μm, and the spot size of light with an intensity ratio of 13.5% or more is φ22 μm. The “intensity ratio” is defined as the ratio of intensity to the highest intensity of light reaching end face 123 of optical transmission member 120.

As illustrated in FIGS. 5A to 5C on the other hand, the spot size varied greatly depending on the environmental temperature (0° C., 25° C., 70° C.) in the optical module according to the comparative example. The reason therefor can be considered as follows: light emitted from the second optical surface is condensed at one point; therefore, the comparative example greatly suffers the effect of shifting of the position of the focal point of the second optical surface or the position of the end face of optical transmission member caused by expansion or contraction of the optical receptacle due to the change in the ambient temperature. When the ambient temperature is 0° C., the spot size of light with an intensity ratio of 50% or more is φ15 μm, and the spot size of light with an intensity ratio of 13.5% or more is φ23 μm. When the ambient temperature is 25° C., the spot size of light with an intensity ratio of 50% or more is φ15 and the spot size of light with an intensity ratio of 13.5% or more is φ18 μm. When the ambient temperature is 70° C., the spot size of light with an intensity ratio of 50% or more is φ12 μm, and the spot size of light with an intensity ratio of 13.5% or more is φ16 μm.

In the present embodiment, first region 135 is disposed at first optical surface 131; however, first region 135 may be disposed at second optical surface 132. As long as the above function is obtained, a region, i.e., a portion of first optical surface 131, and a region, i.e., a portion of second optical surface 132, may be configured to exhibit the function of first region 135.

### Effects

As described above, in optical receptacle 130 according to the present embodiment, light emitted from second optical surface 132 is condensed within a predetermined range on the central axis (second central axis CA2) of second optical surface 132 instead of at one point on the central axis (second central axis CA2) of second optical surface 132. End face 123 of optical transmission member 120 is fixed so as to be located within this range even when the ambient temperature changes; thus the coupling efficiency can be maintained even when the ambient temperature changes.

### Embodiment 2

In the following, optical module 200 according to Embodiment 2 will be described.

Configuration of Optical Module

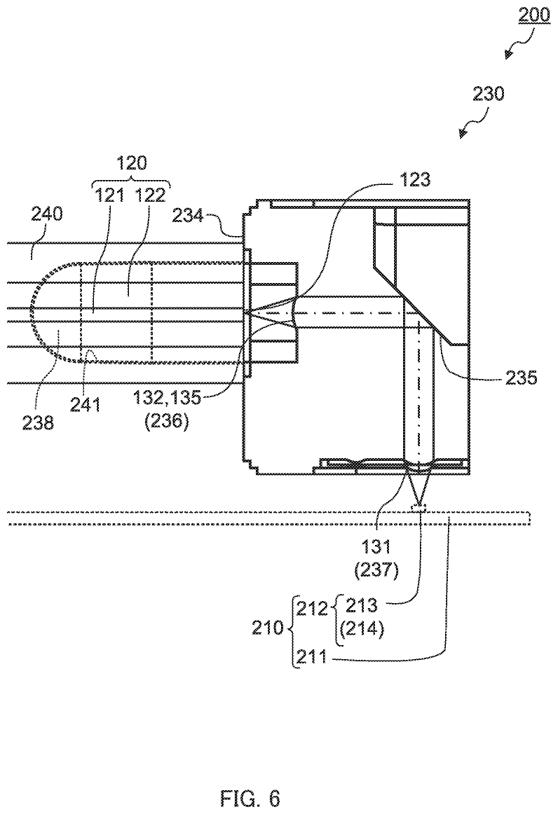

FIG. 6 is a cross-sectional view of optical module 200 according to Embodiment 2 of the present invention. In FIG. 6, photoelectric conversion device 210 is indicated by a dotted line. In addition, hatching of optical module 200 is omitted for the illustration of optical paths in FIG. 6.

As illustrated in FIG. 6, optical module 200 according to the present embodiment includes at least one optical transmission member 120 and optical receptacle 230. Optical module 200 is connected to photoelectric conversion device 210 with optical transmission members 120 connected to optical receptacle 230. Optical module 100 according to the present embodiment is an optical module for transmission and reception.

Photoelectric conversion device 210 includes substrate 211 and at least one photoelectric conversion element 212. Photoelectric conversion element 212 and optical module 200 are disposed on or above substrate 211. In the present embodiment, substrate 211 is disposed in such a way that the surface thereof is parallel to the installation surface of optical receptacle 230. Substrate 211 may be formed of any material. Examples of substrate 211 include glass composite substrates and glass epoxy substrates.

Photoelectric conversion elements 212 are composed of light emitting elements 213 and light receiving elements 214, and disposed on substrate 211. Photoelectric conversion device 210 includes four light emitting elements 213 and four light receiving elements 214 as photoelectric conversion elements 112. Light emitting element 213 is, for example, a vertical cavity surface emitting laser (VCSEL). Light receiving element 214 is, for example, a photodetector. In the present embodiment, the light emitting surfaces of the light emitting elements 213 are disposed parallel to the light receiving surfaces of light receiving elements 214.

Optical transmission member 120 is the same as optical transmission member 120 of Embodiment 1; thus description of the structure thereof is omitted. Optical transmission members 120 are connected to optical receptacle 230 via ferrule 240. In ferrule 240, recesses 241 for the ferrule (herein also referred to as “ferrule recess(es) 241”) corresponding to described-below protrusions 238 for the ferrule (herein also referred to as “ferrule protrusion(s) 238”) of optical receptacle 230 are formed. Fitting ferrule recesses 241 into ferrule protrusions 238 can fix end faces 123 of optical transmission members 120 at a predetermined position with respect to optical receptacle 230.

Configuration of Optical Receptacle

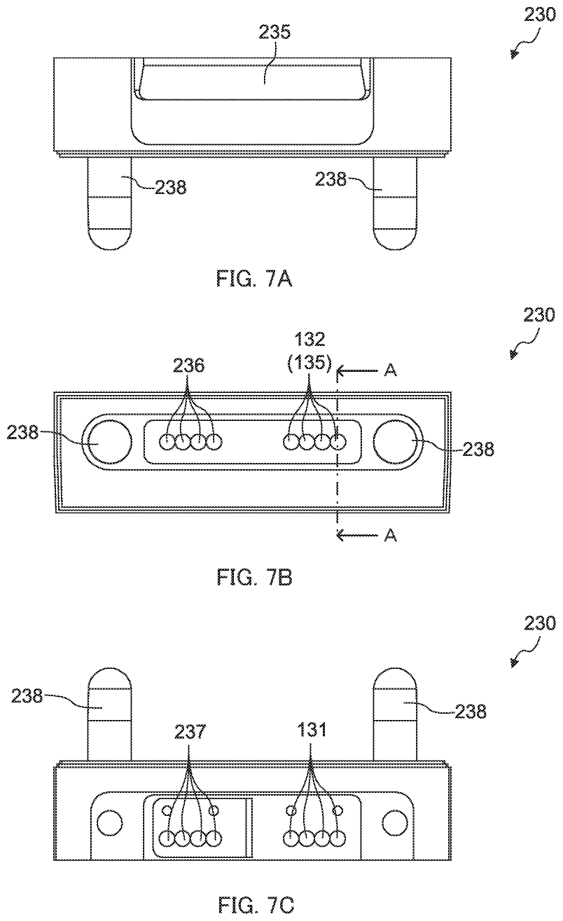

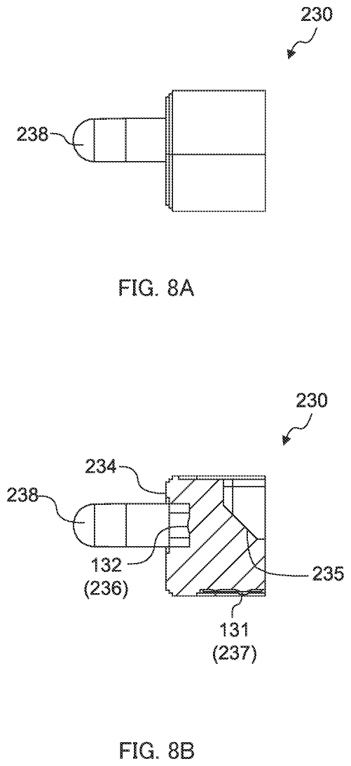

FIGS. 7A to 7C and 8A and 8B illustrate the structure of optical receptacle 230 according to Embodiment 2 of the present invention. Regarding optical receptacle 230, FIG. 7A is a front view, FIG. 7B is a plan view, and FIG. 7C is a bottom view. FIG. 8A is a right side view of optical receptacle 230, and FIG. 8B is a cross-sectional view taken along line A-A of FIG. 7B.

Optical receptacle 230 is a member having a substantially cuboidal shape. Optical receptacle 230 includes first optical surfaces 131, second optical surfaces 132, positioning part 234 (fixing part), and first regions 135. In addition to the above components, optical receptacle 230 further includes reflection surface 235 (another optical surface), third optical surfaces 236, and fourth optical surfaces 237, in the present embodiment. First optical surfaces 131, second optical surfaces 132, and a portion of reflection surface 235 are used during transmission. Third optical surfaces 236, fourth optical surfaces 237, and another portion of reflection surface 235 are used during reception. An optical surfaces on the optical path in the optical receptacle 230 includes first optical surfaces 131, second optical surfaces 132, and reflection surface 235 (another optical surface).

First optical surfaces 131 are disposed in optical receptacle 230 on the surface (bottom surface) facing substrate 211 so that first optical surfaces can face corresponding light emitting elements 213. The number of first optical surfaces 131 is the same as the number of light emitting elements 213. In the present embodiment, four first optical surfaces 131 are arranged on the same straight line. First optical surface 131 has the same structure as first optical surface 131 in Embodiment 1; thus description thereof is omitted.

Second optical surfaces 132 are disposed at the front of optical receptacle 230 so that the second optical surfaces can face corresponding end faces 123 of optical transmission members 120 for transmission. In the present embodiment, second optical surface 132 includes first region 135. The number of second optical surfaces 132 is the same as the number of first optical surfaces 131. In the present embodiment, four second optical surfaces 132 are arranged on the same straight line. In the present embodiment, second optical surface 132 is a surface of a convex lens convex toward optical transmission member 120. In the present embodiment, in the similar manner as in the previous embodiment, second first optical surface 132 includes first region (region). The first region is configured in such a way that as the distance from the emission position of light on second optical surface 132 to the center of second optical surface 132 increases, the distance from a position, where the light intersects the central axis of second optical surface 132 (second central axis CA2), to second optical surface 132 increases. Other structures of second optical surface 132 are the same as those of second optical surface 132 in Embodiment 1; thus description thereof is omitted.

Positioning part 234 is a portion of the front surface of optical receptacle 230. Positioning part 234 holds end faces 123 of optical transmission members 120 via ferrule 240 in such a way that the end faces face second optical surfaces 132. In the present embodiment, in the entire temperature range from −40 to +85° C., positioning part 234 preferably fixes optical transmission members 120 in such a way that each end face 123 is located between the following positions: a position, where light emitted from the vicinity of the center of second optical surface 132 (excluding the center of second optical surface 132) intersects the central axis (second central axis CA2) of second optical surface 132; and a position, where light emitted from the vicinity of the outer edge of the first region of second optical surface 132 intersects the central axis (second central axis CA2) of the second optical surface 132. In addition, a pair of ferrule protrusions 238, 238 for fixing ferrule 240—with optical transmission members 120 inserted in ferrule 240—are disposed at the both ends of positioning part 234. Ferrule protrusion 238 is fitted into ferrule recess 241 formed in ferrule 240 configured for optical transmission members 120 as described above. In the present embodiment, ferrule protrusion 238 is substantially cylindrical.

Reflection surface 235 reflects light having entered through first optical surface 131 toward second optical surface 132 (internal reflection), and reflects light having entered through third optical surface 236 toward fourth optical surface 237 (internal reflection). In the present embodiment, reflection surface 235 is inclined in such a way that the distance from the reflection surface to optical transmission member 120 (second optical surfaces 132) decreases from the bottom surface side toward the top surface side of optical receptacle 230. In the present embodiment, reflection surface 235 has an inclination angle of 45° with respect to the optical axis of light incident on reflection surface 235.

Third optical surface 236 is configured to allow light emitted from optical transmission member 120 to enter optical receptacle 230. Third optical surfaces 236 are disposed at the front of optical receptacle 230 so that the third optical surfaces can face corresponding optical transmission members 120 for reception. The number of third optical surfaces 236 is the same as the number of optical transmission members 120 for reception. In the present embodiment, four third optical surfaces 236 are disposed. Third optical surfaces 236 are disposed to face the same direction as second optical surfaces 132. In the present embodiment, second optical surface 132 and third optical surfaces 236 are positioned on the same straight line.

Third optical surface 236 may have any shape. In the present embodiment, third optical surface 236 is a surface of a convex lens convex toward end face 123 of optical transmission member 120. In addition, the shape of third optical surface 236 in plan view is circular. The central axis of third optical surface 236 may or may not be perpendicular to end face 123 of optical transmission member 120. In the present embodiment, the central axis of third optical surface 236 is perpendicular to end face 123 of optical transmission member 120. The central axis of third optical surface 236 may or may not coincide with the optical axis of light emitted from end face 123 of optical transmission member 120. In the present embodiment, the central axis of third optical surface 236 coincides with the optical axis of light emitted from end face 123 of optical transmission member 120.

A pair of ferrule protrusions 238, 238 for fixing ferrule 240—with optical transmission members 120 inserted in ferrule 240—are disposed outside the both ends of second optical surfaces 132 and third optical surfaces 236. Ferrule protrusion 238 is fitted into ferrule recess 241 formed in ferrule 240 configured for optical transmission members 120 as described above. In the present embodiment, ferrule protrusion 238 is substantially cylindrical.

Fourth optical surface 237 is an emission surface for emitting light—incident on third optical surface 236 and traveling inside optical receptacle 230—toward light receiving element 214. Fourth optical surfaces 237 are disposed in optical receptacle 230 on the surface (bottom surface) facing substrate 211 so that fourth optical surfaces can face corresponding light receiving elements 214. The number of fourth optical surfaces 237 is the same as the number of light receiving elements 214. In the present embodiment, four fourth optical surfaces 237 are disposed. Four fourth optical surfaces 237 are disposed to face the same direction as first optical surfaces 131. In the present embodiment, first optical surface 131 and fourth optical surfaces 237 are positioned on the same straight line.

Fourth optical surface 237 may have any shape. In the present embodiment, fourth optical surface 237 is a surface of a convex lens convex toward light receiving element 214. In addition, the shape of fourth optical surface 237 in plan view is circular. The central axis of fourth optical surface 237 may or may not be perpendicular to the light receiving surface of light receiving element 214. In the present embodiment, the central axis of fourth optical surface 237 is perpendicular to the light receiving surface of light receiving element 214. The central axis of fourth optical surface 237 may or may not coincide with the central axis of the light receiving surface of light receiving element 214. In the present embodiment, the central axis of fourth optical surface 237 coincides with the central axis of the light receiving surface of light receiving element 214.

The present embodiment describes optical module 200 for transmission and reception; however, the optical module may be used for transmission. In this case, photoelectric conversion element 112 serves as light emitting element 213. Optical receptacle 230 would not include third optical surface 236 or fourth optical surface 237. In addition, first region 135 is disposed at second optical surface 132 in the present embodiment; however, first region 135 may be disposed at first optical surface 131 or reflection surface 235. As long as the above function is obtained, at least two of first optical surface 131, second optical surface 132, and reflection surface 235 may be configured to exhibit the function of first region 135.

### Effects

As described above, optical receptacle 230 according to the present embodiment has the same effects as optical receptacle 130 according to the first embodiment.

### INDUSTRIAL APPLICABILITY

The optical receptacles and optical modules according to the present invention are advantageous for optical communications using an optical transmission member.

### REFERENCE SIGNS LIST

100, 200 Optical module
110 Photoelectric conversion element package
111 Housing
112, 212 Photoelectric conversion element
113 Lead
120 Optical transmission member
121 Core
122 Cladding
123 End face
130, 230 Optical receptacle
131 First optical surface
132 Second optical surface
133 Fixing part
134, 234 Positioning part
135 First region
210 Photoelectric conversion device
211 Substrate
213 Light emitting element
214 Light receiving element
235 Reflection surface
236 Third optical surface
237 Fourth optical surface
238 Ferrule protrusion
240 Ferrule
241 Ferrule recess
CA1 First central axis
CA2 Second central axis

What is claimed is:

1. An optical receptacle configured to optically couple a photoelectric conversion element with an optical transmission member when the optical receptacle is disposed between the photoelectric conversion element and the optical transmission member, the optical receptacle comprising:
a first optical surface configured to allow light emitted from the photoelectric conversion element to enter the optical receptacle;
a second optical surface configured to emit, toward the optical transmission member, the light having entered through the first optical surface;
a positioning part configured to position an end face of the optical transmission member in such a way that the end face faces the second optical surface; and
a region disposed at at least one of the first optical surface, the second optical surface, or another optical surface on an optical path in the optical receptacle, wherein the region is configured in such a way that as a distance from an emission position of the light on the second optical surface to a center of the second optical surface increases, a distance from a position where the light intersects a central axis of the second optical surface to the second optical surface increases.

2. The optical receptacle according to claim 1, wherein, in an entire temperature range from −40 to +85° C., the positioning part positions the optical transmission member in such a way that the end face is positioned within a range in which light emitted from the region reaches the central axis.

3. The optical receptacle according to claim 1, wherein the region is configured in such a way that a distance (1) is longer than a distance (2), the distance (1) being a distance between point A where light emitted from a point at a distance n from the central axis intersects the central axis, and point B where light emitted from a point at a distance n+a from the central axis intersects the central axis, the distance (2) being a distance between point C where light emitted from a point at a distance m (where m>n) from the central axis intersects the central axis, and point D where light emitted from a point at a distance m+a from the central axis intersects the central axis.

4. The optical receptacle according to claim 1, wherein the region is circularly symmetrical.

5. The optical receptacle according to claim 1, wherein the region is disposed at one of the first optical surface or the second optical surface.

6. The optical receptacle according to claim 5, wherein the one of the first optical surface or the second optical surface is a convex.

7. The optical receptacle according to claim 1, further comprising, a reflection surface disposed on an optical path between the first optical surface and the second optical surface, the reflection surface being configured to reflect, toward the second optical surface, the light having entered through the first optical surface.

8. The optical receptacle according to claim 7, wherein the region is disposed at the reflection surface.

9. The optical receptacle according to claim 8, wherein the reflection surface is a convex.

10. An optical module, comprising:
an optical transmission member; and
the optical receptacle according to claim 1.
